(19) United States
(12) Patent Application Publication
(10) Pub. No.: US 2004/0070209 A1
(43) Pub. Date: Apr. 15, 2004

(54) Support structure for pinion pusher of starter for internal combustion engine

(75) Inventors: Tsutomu Shiga, Nukata-gun (JP); Masami Niimi, Handa-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/677,345

(22) Filed: Oct. 3, 2003

(30) Foreign Application Priority Data
Oct. 4, 2002 (JP) 2002-292267

(51) Int. Cl. F02N 1/00; H02P 9/04

(52) U.S. Cl. 290/38 R; 74/7 E

(57) ABSTRACT

A starter for automotive internal combustion engines is provided which includes a starter output shaft with a pinion which establishes engagement with a ring gear of the engine and a spline tube. The starter output shaft is disposed within the spline tube in splined engagement therewith. The spline tube is supported firmly by a housing through at least two bearings, thereby avoiding precession or wrenching of a pinion-mounted portion of the starter output shaft projecting from the housing about an outside one of the bearings.

### BACKGROUND OF THE INVENTION

1. Technical Field of the Invention

The present invention relates generally to a starter working to start an internal combustion engine of automotive vehicles, and more particularly to an improved support structure for a pinion pusher of such a starter.

2. Background Art

Recent years, installation of an automotive starter has been subjected to various physical constraints. For instance, the starter is required to withstand poor environments such as damp, dirty, and dusty conditions and be disposed within a very small space.

Japanese Patent Second Publication No. 6-10954 teaches a pinion cantilever structure (or an overhang structure) in which a motor-driven shaft with a pinion is withdrawn into a housing of a starter when the starter is placed at rest to prevent the motor-driven shaft from being splashed with water. The motor-driven shaft is arranged in parallel to an output shaft of the motor, thus requiring increase in rigidity of a motor support, which results in increased weight and size of the starter. In order to alleviate this problem, DE 100 16 706 A1 teaches a starter which includes a planetary reduction gear with an internal gear working to reduce the speed of an output shaft of the motor and cantilevers a pinion installed on a motor-driven shaft for achieving reduction in size and protect the starter from mud, etc, but however, has a serious problem. Specifically, as shown in FIG. 3 of the publication, the motor-driven shaft 72 is supported only by the bearing 80. When the motor-driven shaft 72 moves to the left, as viewed in the drawing, to start the engine, the pinion 180 installed on an end of the motor-driven shaft 72 overhangs the bearing 80, which results in inclination of the bearing 80 during use of the starter. Specifically, the bearings 176 and 160 are used to support the drive shaft 58. The bearing 176 is installed on the drive shaft 58. The bearing 160 is installed on an inner wall of a body of the starter. The bearing 176 has a certain gap between itself and the motor-driven shaft 72 to allow the motor-driven shaft 72 to rotate and move in an axial direction thereof. Specifically, only the bearings 58 and 160 are firmly mounted on the body of the starter to support the drive shaft 58 and the motor-driven shaft 72. Thus, if the load acts on the pinion 180 when the engine is started, it will cause the drive shaft 58 and the motor-driven shaft 72 to precess or wrench about the bearings 176 and 160, which results in undesirable mechanical vibrations and wear thereof.

### SUMMARY OF THE INVENTION

It is therefore a principal object of the invention to avoid the disadvantages of the prior art.

It is another object of the invention to provide a starter which is designed to support a motor-driven shaft with a pinion firmly and/or may be used in poor environments such as such as damp, dirty, and dusty conditions.

According to one aspect of the invention, there is provided a starter for an internal combustion engine which comprises: (a) a housing; (b) a spline tube disposed within the housing, the spline tube having a spline formed in an inner periphery thereof; (c) at least two bearings working to support an outer periphery of the spline tube; (d) a starter output shaft having a spline which is slidable engagement with the spline of the spline turbe, the starter output shaft having a pinion which is provided on an end portion of the starter output shaft cantilevered by one of the bearings and which works to mesh with a ring gear of an engine for outputting torque produced by a motor to start the engine; (e) at least one elongated hole formed in the spline tube; (f) an engagement member engaging the starter output shaft through the elongated hole of the spline tube; and (g) a pinion moving mechanism responsive to activation of the starter to push the engagement member for moving the pinion toward the ring gear along with movement of the engagement member along the elongated hole.

Specifically, the spline tube working to drive or rotate the starter output shaft is supported by the at least two bearings mounted firmly on the housing. The starter output shaft with the pinion is retained within the spline tube, thereby avoiding precession or wrenching of the starter output shaft about an outside one of the bearings which will arise in the conventional structures when the pinion meshes with the ring gear to start the engine. This results in an increased service life of the starter. The starter output shaft is moved or pushed by the pinion moving mechanism through the engagement member engaging the starter output shaft through the elongated hole of the spline tube, thus enabling the starter output shaft to be disposed coaxially with the spline tube, which allows the size of the starter to be reduced.

In the preferred mode of the invention, the spline tube is coupled to the motor so that the torque produced by the motor is transmitted to the starter output shaft and the pinion through the spline of the spline tube, thereby increasing the reliability of transmission of the output of the motor to the pinion. The starter also includes a push mechanism working to convert the torque of the motor through the pinion moving mechanism into pressure serving to push the starter output shaft disposed within the spline tube.

The push mechanism may alternatively be designed to directly push the engagement member extending from the starter output shaft through the spline tube to move the starter output shaft disposed within the spline tube.

The splines of the spline tube and the starter output shaft are spiral. The elongated hole extends at an angle to a longitudinal center line of the spline tube which is equivalent to a spiral angle of the splines, thereby eliminating the physical interference of the engagement member with the elongated hole when the starter output shaft is rotated by activities of the splines.

The pinion moving mechanism is implemented by a magnet switch which is electrically energized for moving the starter output shaft toward the ring gear, thereby providing a simple structure to the pinion moving mechanism.

If a span between the bearings supporting the spine tube is defined as B, and a distance between one of the bearing close to the pinion and the pinion when the pinion is moved furthest from the housing and establishes engagement with the ring gear is defined as A, a relation of A/B<1 is satisfied. This increases the mechanical stability of the cantilevered end portion of the starter output shaft when drawn to the ring gear.

The starter output shaft has a length longer than the distance B which is supported in engagement with spline tube. In other words, an overhang of the starter output shaft from the housing of the starter (i.e., an outside one of the bearings) is shorter than a bearing span of the starter output shaft (i.e., the span A), thus resulting in a decreased stress acting on the starter output shaft.

The spline tube has a first end portion opposed to a second end portion closer to the pinion. The first end portion serves as a part of a clutch working to transmit the torque of the motor to the spline tube. This allows the length of the spline tube to be increased by a width of the clutch, thus resulting in an increase in the bearing span.

The starter also includes a planetary reduction gear disposed between an output shaft of the motor and the spline tube. Use of the planetary reduction gear allows the starter output shaft to be fined.

The magnet switch is disposed on a side of the motor further from the starter output shaft. The magnet switch is designed to produce magnetic force working to hold the engagement member from rotating while allowing the starter output shaft to be pushed to the ring gear through spiral action of the splines of the starter output shaft and the spline tube produced by the torque of the motor. Use of this type of magnetic switch allows the size thereof to be reduced and the magnetic switch to be located behind the motor, thus permitting the size of the starter to be reduced.

The magnet switch may alternatively be designed to produce magnetic force which moves the engagement member through a lever to push the pinion toward the ring gear through the starter output shaft. This increases the reliability of movement of the starter output shaft.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a starter for internal combustion engines according to the invention;

FIG. 2 is a partial sectional view which shows a starter output shaft of the starter as illustrated in FIG. 1;

FIG. 3 is a sectional view taken along the line C-C in FIG. 2;

FIG. 4 is a longitudinal partial sectional view which shows a spline tube;

FIG. 5 is a longitudinal sectional view which shows the starter, as illustrated in FIG. 1, when a pinion is drawn outside a housing of the starter for engagement with a ring gear of an engine;

FIG. 6 is a longitudinal sectional view which shows the starter, as illustrated in FIG. 1, when a pinion is drawn outside a housing of the starter and engages a ring gear of an engine; and

FIG. 7 is a partial longitudinal sectional view which shows a starter for internal combustion engines according to the second embodiment of the invention.

### DESCRIPTION OF THE PREFERRED EMBODIMENTS

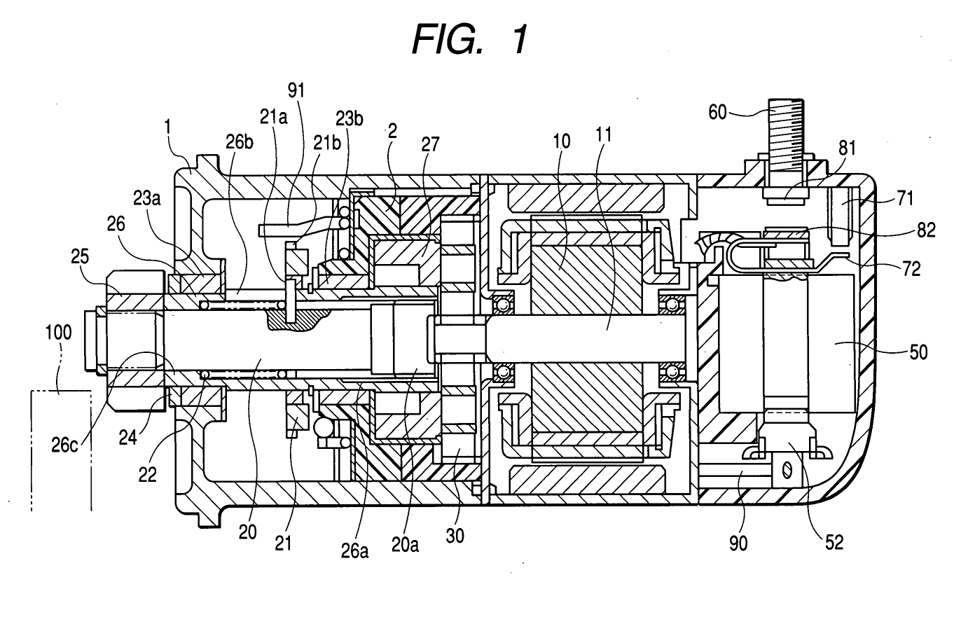

Referring to the drawings, wherein like reference numbers refer to like parts in several views, particularly to FIG. 1, there is shown a starter for automotive internal combustion engines according to the first embodiment of the invention.

The starter includes a housing 1 and a cylindrical spline tube 26 installed in the housing 1. The spline tube 26 has installed therein a spiral spline 26a, as clearly shown in FIG. 4, which is in slidable engagement with a spiral spline 20a provided on a motor-driven shaft 20 to be rotated by the motor through the spiral tube 26. The motor-driven shaft 20 will also be referred to as a starter output shaft below. The spline tube 26 has formed therein, as clearly shown in FIG. 4, at least one elongated hole or slit 26b extending at an angle substantially identical with a spiral angle of keys or ridges of the spline 26a to a longitudinal center line of the spline tube 26. In this embodiment, the two slits 26b are formed in the spline tube 26 so as to be opposed diametrically with each other. The spline tube 26 is rotatably supported by two bearings 23a and 23b. More than two bearings may alternatively be used to support the spline tube 26. The spline tube 26 has shoulders and an annular slit 26d within which a washer is, as can be seen in FIG. 1, fit. An outermost one of the shoulders and the washer serve to hold the spline tube 26 from moving in a lengthwise direction thereof between the bearings 23a and 23b.

The bearing 23a is mounted on an inner wall of the housing 1. The bearing 23b is mounted on an inner wall of a center housing 2 disposed within the housing 1. The starter output shaft 20 is disposed within the spline tube 26 in engagement with an inner periphery of the spline tube 26. The starter output shaft 20 meshes at an outer periphery thereof with an inner periphery 26c of the spline tube 26 so that it is slidable. The spline 20a meshes with the spline 26a in outer diameter matching to locate the center of the starter output shaft 20 within the spline tube 26. The spline 26a may alternatively be provided to mesh with the spline 20a in inside diameter matching. The splines 20a and 26a may alternatively mesh with each other in tooth flank matching. Centering members working to place the starter output shaft 20 coaxially with the spline tube 26 may also be provided in addition to the splines 20a and 26a. Specifically, it is advisable that at least two members be employed to center the starter output shaft 20 within the spline tube 26.

The starter output shaft 20 has a pinion 25 installed on a head thereof in a suitable known manner. The pinion 25 may alternatively be formed integrally on the head of the starter output shaft 20.

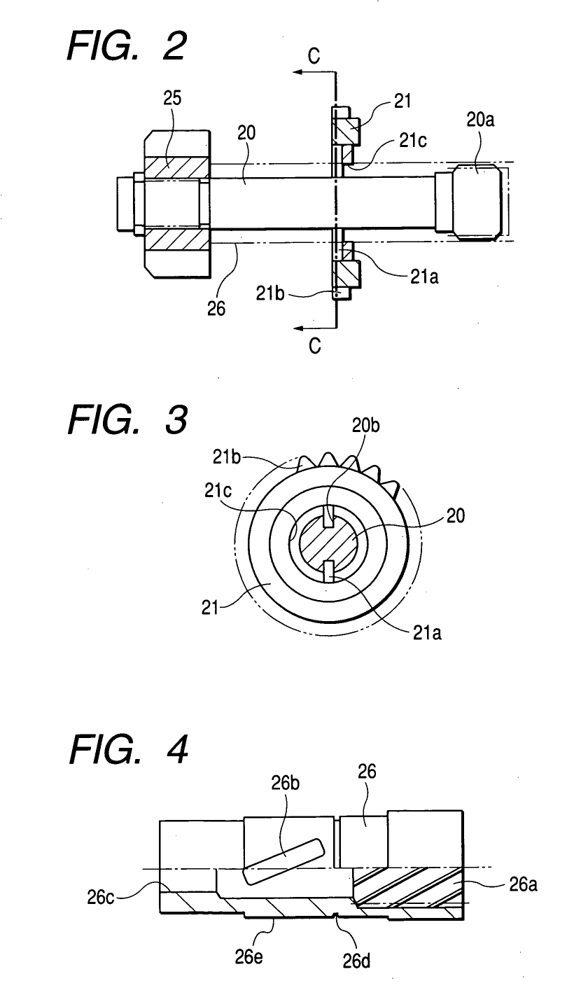

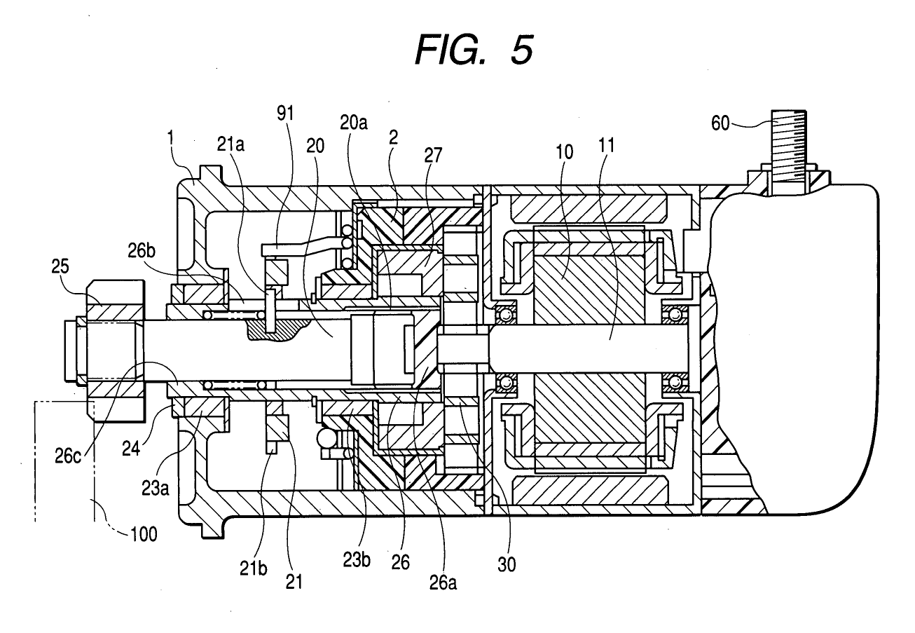

The starter output shaft 20 has formed in a central portion thereof, as clearly shown in FIG. 3, two holes 20b in which pins 21a are, as shown in FIGS. 1 and 2, press fit through the slits 26b so that they may move along with the starter output shaft 20. The pines 21a may alternatively be in an interference or clearance fit in the holes 20b and be made of a square bar as well as a round bar. Instead of the pines 21a, a single pin may alternatively be inserted through the holes 20b. A thrust bearing 21 is mounted on the pins 21a in a suitable manner. The thrust bearing 21 has an inner periphery 21c engaging an outer periphery6 26e of the spline tube 26 to guide movement of the thrust bearing 21 along the length of the spline tube 26 and enhance the rigidity of the thrust bearing 21. The return spring 22 is, as shown in FIG. 1, installed around the starter output shaft 20 and, after the engine has been started, pushes the pins 21a to return the starter output shaft 20 back to an initial position thereof.

The starter also includes, as shown in FIG. 1, a clutch 27, a planetary reduction gear 30, an armature 10, an armature shaft 11, a stationary contact 81, a movable contact 82, and a terminal 60 leading to a terminal (+) of a battery (not shown) mounted in the vehicle. The armature 10 and the armature shaft 11 constitute an electric motor. The clutch 27 includes an end portion of the spline tube 26 as a component thereof and works to establish mechanical engagement with the spline tube 26 selectively. The armature shaft 11 is joined to the starter output shaft 20 through the planetary reduction gear 30, the clutch 27, and the spline tube 26 to transmit torque of the motor to the starter output shaft 20. The movable contact 82 is connected to ground (i.e., a body of the vehicle). The stationary contact 81 is electrically connected to the terminal 60. When the stationary contact 81 and the movable contact 82 are closed, the power is supplied from the battery to the motor. The starter also includes a brush 71, a movable contact 72, and a magnet switch 50. The brush 71 is made of a carbon-based material and works as a resistor. The brush 71 is electrically joined to the terminal 60 and works as a stationary contact used to make a sub-contact with the movable contact 72. The movable contact 72 is joined to the movable contact 82. The movable contacts 72 and 82 are attracted by the magnet switch 50 upon activation thereof toward the stationary contacts 71 and 81 and function as a switch as a whole which activates the motor.

The magnet switch 50 includes a plunger 52. The movement of the plunger 52 is transmitted to a stopper 91 through a connecting rod 90 (details of a connection of the connecting rod 90 with the stopper 91 are omitted from FIG. 1). The thrust bearing 21 has provided on the outer periphery thereof a toothed ring 21b which is fixedly connected to the pins 21c. The stopper 91 is made of a bar member and engages one of tooth spaces of the ring 21b to hold the starter output shaft 20 from rotating while allowing the starter output shaft 20 to move in the longitudinal direction thereof. A seal 24 is disposed between the spline tube 26 and the inner wall of the housing 1 to avoid intrusion of dust, etc. into the bearing 23a and the starter.

In operation, when a key switch (not shown) of the vehicle is turned on, the magnet switch 50 is energized to produce magnetic attraction which, in turn, draws the plunger 52. The movement of the plunger 52 will cause the connecting rod 90 to move, which brings the stopper 91 into engagement with the toothed ring 21b, thereby holding the starter output shaft 20 from rotating. Further movement of the plunger 52 will cause the sub-movable contact 72 to abut the stationary contact 71. This causes the current from the battery to flow through the stationary contact 71 working as a resistor. Specifically, the current from the battery is limited by the stationary contact 71 to, for example, 200A and supplied to the motor. This causes the armature 10 to start to turn slowly, so that the spline tube 26 rotates at a reduced speed through the armature shaft 10, the planetary reduction gear 30, and the clutch 27. The starter output shaft 20 is, as described above, inhibited from rotating by the stopper 91, but screw activities of the spiral spline 20a and 26a cause the starter output shaft 20 to be moved to the left, as viewed in FIG. 1, by the guidance of the pines 21a along the slits 26b until the pinion 25 abuts an end surface of the ring gear 100.

Upon the abutment of the pinion 25 with the ring gear 100, the starter output shaft 20 is inhibited from moving further, but the stopper 91 has a small elasticity, thus causing the starter output shaft 20 to start to rotate along with the spline tube 26. During rotation of the starter output shaft 20 and the spline tube 26 through an angle corresponding to one of the teeth of the pinion 25, the teeth of the pinion 25 are moved out of abutment to the end surface of the ring gear 100 to eliminate a mechanical interference of the teeth of the pinion 25 with those of the ring gear 100, thereby causing the starter output shaft 20 to move to the left along the slits 26b again.

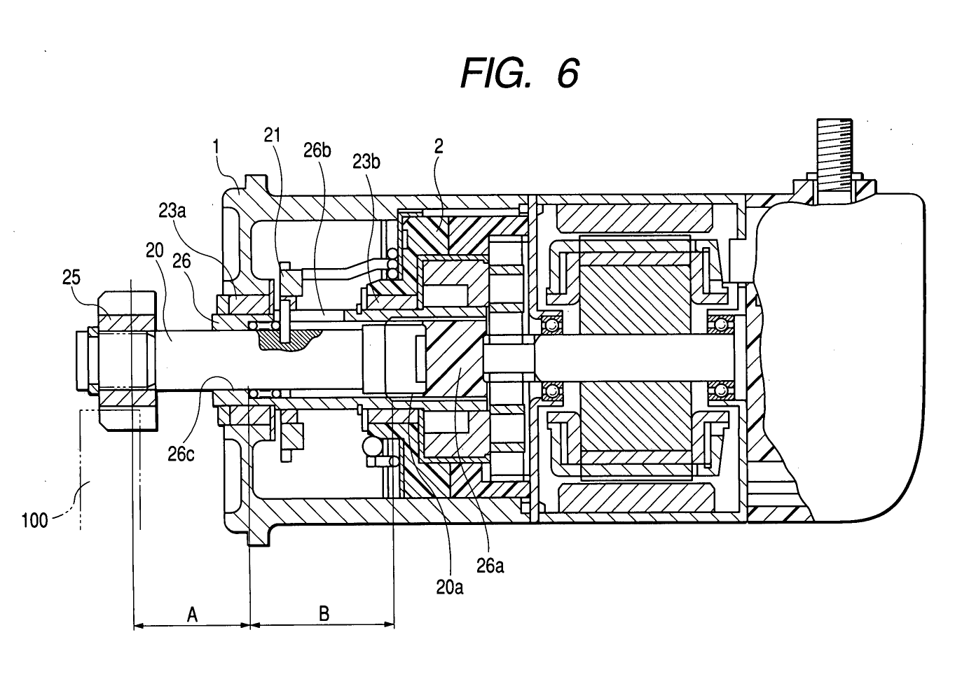

When the starter output shaft 20 moves to the left until the toothed ring 21b disengages from the stopper 91, it causes the pinion 25 to mesh with the ring gear 100 completely and allows the starter output shaft 20 from rotating. Upon the disengagement of the ring 21b from the stopper 91, the stopper 91 moves inwardly in a radius direction of the starter (i.e., downward, as viewed in FIG. 1) and faces, as can be seen from FIG. 6, a side surface of the thrust bearing 21. When this condition is encountered, the plunger 52 makes an electric contact between the stationary contact 81 and the movable contact 82, so that a greater current (e.g., 800A) flows from the battery to the motor (i.e., the armature 10) without passing through the brush 71 (i.e., the resistor), thereby causing the motor (i.e., the armature shaft 11) to rotate to produce full power, which starts the engine through the pinion 25 and the ring gear 100. The reaction force acting on the pinion 25 at the start of the engine is carried by the stopper 91 through the thrust bearing 21. Other operations are identical with those of a starter as disclosed in Japanese Patent First Publication No. 10-115274 (corresponding to U.S. Pat. No. 5,945,742, issued Aug. 31, 1999, assigned to the same assignee as that of this application, disclosure of which is incorporated herein by reference).

As apparent from the above discussion, the starter output shaft 20 and the spline tube 26 are supported by the two bearings 23a and 23b during driving of the engine, thus avoiding the precession or wrenching of the starter output shaft 20 about the bearings 23a and 23b which is objectionalble in the conventional structure. As clearly shown in FIG. 6, an overhang A of the starter output shaft 20 from the end of the housing 1 (i.e., a distance between the bearing 23a closer to the pinion 25 and the pinion 25 when the pinion 25 is moved furthest from the housing 1) is smaller than a bearing span B (i.e., an interval between the bearings 23a and 23b), thus resulting in decreases in load and stress acting on the bearings 23a and 23b, which improves the reliability of an operation of the starter and allows the starter to be reduced in size. Further, use of the seal 24 enables the starter to be employed in poor environments such as dusty conditions.

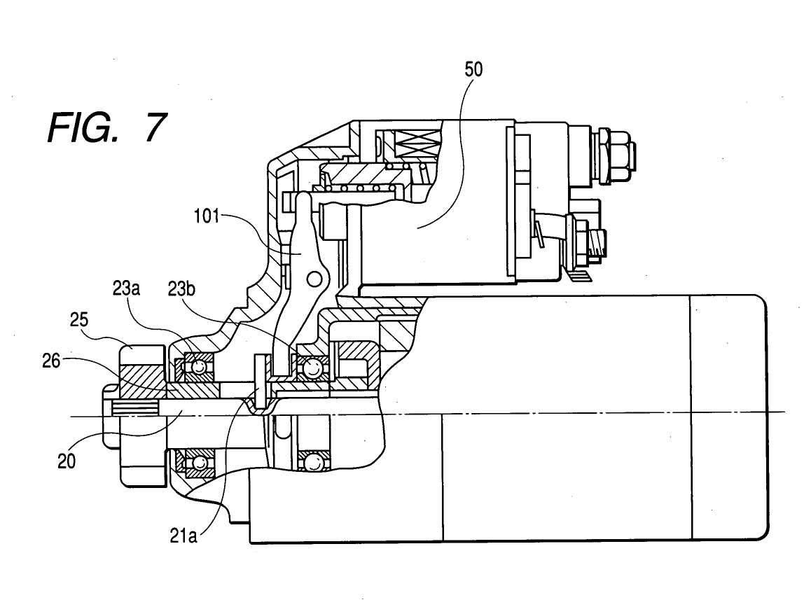

FIG. 7 shows a starter according to the second embodiment of the invention.

The spline tube 26 is supported by the bearings 23a and 23b. The starter output shaft 20 is disposed within the spline tube 26. The magnet switch 50 is installed outside the motor of the starter in parallel thereto. When the magnet switch 50 is energized, a lever 101 swings to move the starter output shaft 20 through the pin 21a in a lengthwise direction thereof, thereby bringing the pinion gear 25 into engagement with the ring gear 100. Other arrangements and operation are identical with those in the first embodiment, and explanation thereof in detail will be omitted here.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A starter for an internal combustion engine comprising:
a housing;
a spline tube disposed within said housing, said spline tube having a spline formed in an inner periphery thereof;
at least two bearings working to support an outer periphery of said spline tube;
a starter output shaft having a spline which is slidable engagement with the spline of said spline turbe, said starter output shaft having a pinion which is provided on an end portion of said starter output shaft cantilevered by one of said bearings and which works to mesh with a ring gear of an engine for outputting torque produced by a motor to start the engine;
at least one elongated hole formed in said spline tube;
an engagement member engaging said starter output shaft through said elongated hole of said spline tube; and
a pinion moving mechanism responsive to activation of the starter to push said engagement member for moving said pinion toward the ring gear along with movement of said engagement member along said elongated hole.

2. A starter as set forth in claim 1, wherein said spline tube is coupled to the motor so that the torque produced by the motor is transmitted to said starter output shaft and the pinion through the spline of said spline tube, and further comprising a push mechanism working to convert the torque of the motor through the pinion moving mechanism into pressure serving to push said starter output shaft disposed within said spline tube.

3. A starter as set forth in claim 1, wherein said spline tube is coupled to the motor to transmit the torque produced by the motor to said starter output shaft and the pinion through the spline of said spline tube, and further comprising a push mechanism working to push said engagement member extending from said starter output shaft through said spline tube to move said starter output shaft disposed within said spline tube.

4. A starter as set forth in claim 1, wherein the splines of said spline tube and said starter output shaft are spiral, and wherein said elongated hole extends at an angle to a longitudinal center line of said spline tube which is equivalent to a spiral angle of said splines.

5. A starter as set forth in claim 1, wherein said pinion moving mechanism is implemented by a magnet switch which is electrically energized for moving said starter output shaft toward the ring gear.

6. A starter as set forth in claim 1, wherein if a span between said bearings supporting said spine tube is defined as B, and a distance between one of said bearing close to the pinion and the pinion when the pinion is moved furthest from said housing and establishes engagement with the ring gear is defined as A, a relation of A/B<1 is satisfied.

7. A starter as set forth in claim 6, wherein said starter output shaft has a length longer than the distance B which is supported in engagement with spline tube.

8. A starter as set forth in claim 1, wherein said spline tube has a first end portion opposed to a second end portion closer to the pinion, the first end portion serving as a part of a clutch working to transmit the torque of the motor to said spline tube.

9. A starter as set forth in claim 1, further comprising a planetary reduction gear disposed between an output shaft of the motor and said spline tube.

10. A starter as set forth in claim 1, further comprising a planetary reduction gear disposed between an output shaft of the motor and said starter output shaft and a magnet switch disposed on a side of the motor further from said starter output shaft, and wherein said magnet switch produces magnetic force working to hold said engagement member from rotating while allowing said starter output shaft to be pushed to the ring gear through spiral action of the splines of said starter output shaft and said spline tube produced by the torque of the motor.

11. A starter as set forth in claim 3, wherein said push mechanism includes a magnet switch working to produce magnetic force which moves said engagement member through a lever to push the pinion toward the ring gear through said starter output shaft.
